(19) United States
(12) Patent Application Publication
(10) Pub. No.: US 2010/0192716 A1
(43) Pub. Date: Aug. 5, 2010

(54) SLIDING MODULE FOR SLIDE-TYPE PORTABLE TERMINAL HAVING STOPPER DEVICE

(75) Inventor: Jung-Won PARK, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/699,985

(22) Filed: Feb. 4, 2010

(30) Foreign Application Priority Data
Feb. 5, 2009 (KR) 10-2009-0009379

(51) Int. Cl. F16H 21/44

(52) U.S. Cl. 74/100.1

(57) ABSTRACT

A sliding module for a slide-type portable terminal with a stopper device, which includes a fixed plate, a moving plate slidable over the fixed plate, and an elastic body interposed between the fixed plate and the moving plate and providing an elastic force to slide the moving plate, in which a rivet stopper is formed on each of both ends of the elastic body so that during sliding movement of the moving plate, both ends of the elastic body also rotate and the sliding movement of the moving plate is restricted when rivets provided at both ends of the elastic body make contact.

### CLAIM OF PRIORITY

This application claims the benefit of the earlier filing date, under 35 U.S.C. §119(a), to that patent application filed in the Korean Intellectual Property Office on Feb. 5, 2009 and assigned Serial No. 10-2009-0009379, the entire disclosure of which is hereby incorporated by reference.

### BACKGROUND OF THE INVENTION

1. Field of the Invention

The present invention relates to portable terminals and in particular a sliding module for a slide-type portable terminal.

2. Description of the Related Art

A portable terminal typically represents a device by which a user can wirelessly communicate with another party. Such portable terminals are well-known in the art and include devices such as Hand-Held Phones (HHPs), Cordless Telephone-2 (CT-2) cellular phones, digital phones, Personal Communications Service (PCS) phones, Personal Digital Assistants (PDAs), etc. These devices may be classified into many different types according to their appearances. For example, the portable terminals are classified into bar-type, flip-type, folder-type and slide-type portable terminals according to their appearances. The conventional portable terminals stated above necessarily have an antenna device, a data input/output device, and a data transmission/reception device. As a data input device, a keypad is generally used, with which a user can input data by pressing down keys with a finger.

The slide-type portable terminal includes a main body with a keypad, a sliding body with a display, and a sliding module for sliding the sliding body over the main body.

Referring to FIGS. 1 through 3, a sliding module 1 includes a fixed plate 2 coupled to a main body (not shown), a moving plate 3 coupled to a sliding body 4 that is able to slide over fixed plate 2, and an elastic body (not shown) interposed between the fixed plate 2 and the moving plate 3. The elastic body provides an elastic force to slide the moving plate 3.

A plurality of dampers 5 are provided on the sliding body 4 to damp an impact to the fixed plate 2 when the moving plate 3 slides together with the sliding body 4. The dampers 5 are typically made of rubber.

Conventionally, four (4) dampers 5 are installed in the sliding body 4, which increases the number of parts and the manufacturing cost including the molding cost and requires separate installation spaces. These drawbacks become an obstacle to slimness of the product, making it difficult to accomplish the sophisticated design.

Therefore, there is a need for a stopper device that can absorb an impact with a small number of parts in the slide-type portable terminal.

### SUMMARY OF THE INVENTION

An aspect of the present invention provides a sliding module for a slide-type portable terminal with a stopper device, in which rivet stoppers for restricting sliding movement of a moving plate are formed on both ends of an elastic body in the sliding module, so as to reduce the manufacturing cost by using a small number of parts, and to slim the product and improve the design by reducing the installation spaces.

Another aspect of the present invention provides a sliding module for a slide-type portable terminal with a stopper device, in which a built-in rivet stopper is formed on each of both ends of an elastic body to prevent its exposure to the exterior thereby preventing deformation and damage of the product.

According to one aspect of the present invention, there is provided a sliding module for a slide-type portable terminal with a stopper device, which includes a fixed plate, a moving plate slidable over the fixed plate, and an elastic body interposed between the fixed plate and the moving plate and providing an elastic force to slide the moving plate, in which a rivet stopper is formed on each of both ends of the elastic body so that during sliding movement of the moving plate, both ends of the elastic body also rotate and the sliding movement of the moving plate is restricted when rivets provided at both ends of the elastic body make contact.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a plane view showing dampers on a sliding module for a conventional slide-type portable terminal;

FIG. 2 is a front view showing use of dampers on a sliding module for a conventional slide-type portable terminal;

FIG. 3 is a perspective view showing a state where dampers on a sliding module for a conventional slide-type portable terminal are installed in a sliding body;

FIG. 4 is a disassembled perspective view of a sliding module for a slide-type portable terminal with a stopper device according to an embodiment of the present invention;

FIG. 5 is an enlarged disassembled perspective view of the section A shown in FIG. 4;

FIG. 6 is an internal perspective view showing an engaged state of a sliding module for a slide-type portable terminal with a stopper device according to an embodiment of the present invention;

FIG. 7 is a perspective view showing an engaged state of a sliding module for a slide-type portable terminal with a stopper device according to an embodiment of the present invention;

FIG. 8 is a perspective view showing a state where rivet stoppers are mounted in a sliding module for a slide-type portable terminal with a stopper device according to an embodiment of the present invention;

FIG. 9 is a front view showing a state before sliding movement of a sliding module for a slide-type portable terminal with a stopper device according to an embodiment of the present invention;

FIG. 10 is an enlarged front view of the section B shown in FIG. 9;

FIG. 11 is an enlarged front view of the section C shown in FIG. 9;

FIG. 12 is a front view showing a state after sliding movement of a sliding module for a slide-type portable terminal with a stopper device according to an embodiment of the present invention;

FIG. 13 is an enlarged front view of the section D shown in FIG. 12; and

FIG. 14 is an enlarged front view of the section E shown in FIG. 12.

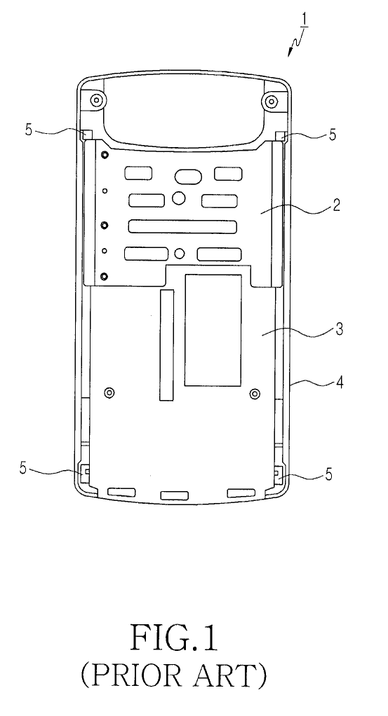

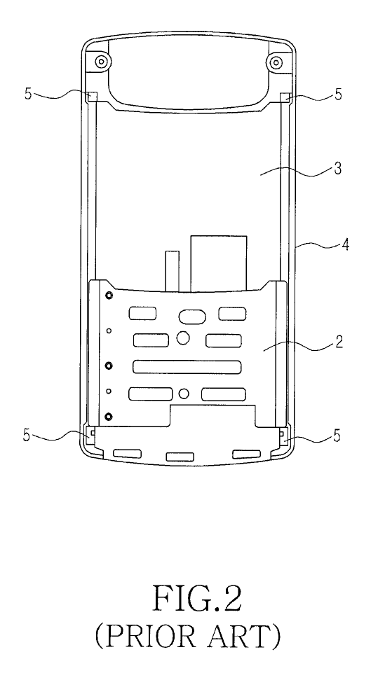

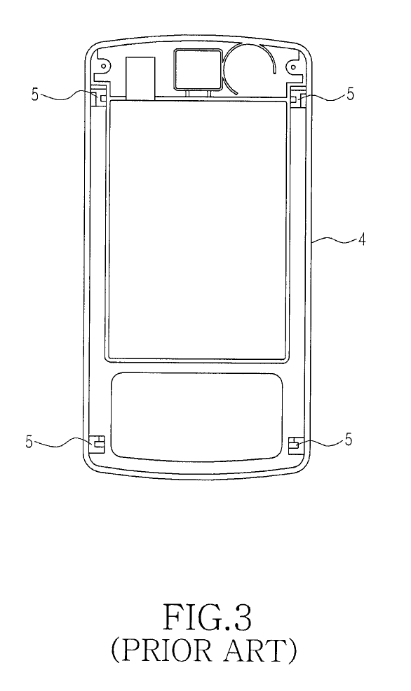

### DETAILED DESCRIPTION OF THE INVENTION

Embodiments of the invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention. Accordingly, those of ordinary skill in the art will recognize that various changes and modifications of the embodiments described herein can be made without departing from the scope and spirit of the invention.

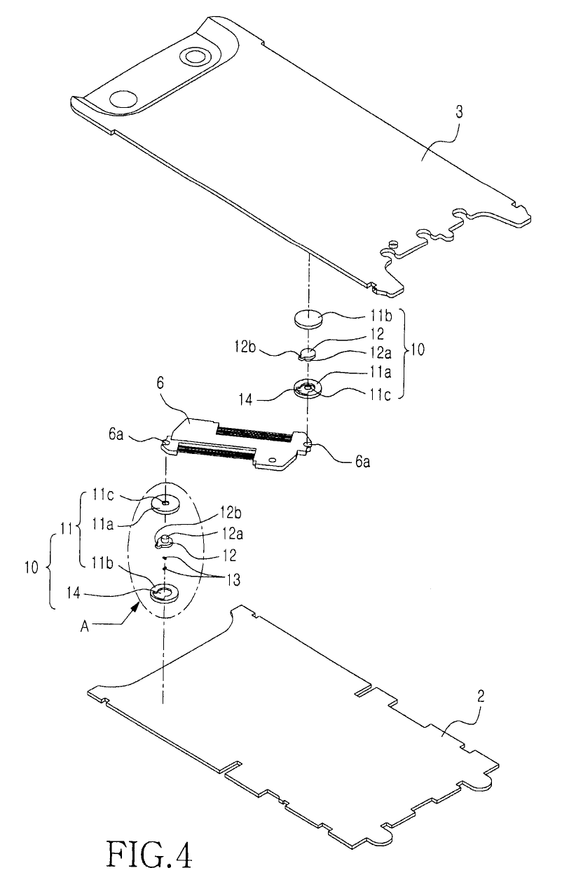

Referring to FIGS. 4 through 14, and more particularly, FIG. 4 illustrates an expanded view of a sliding module for a slide-type portable terminal with a stopper device including a fixed plate 2, a moving plate 3, an elastic body 6, and rivet stoppers 10. The rivet stoppers 10 are formed on both ends of the elastic body 6 so that during sliding movement of the moving plate 3, both ends of the elastic body 6 also rotate and the sliding movement of the moving plate 3 is restricted when rivets 12 provided at both ends of the elastic body 6 make contact with limiting members, as will be described.

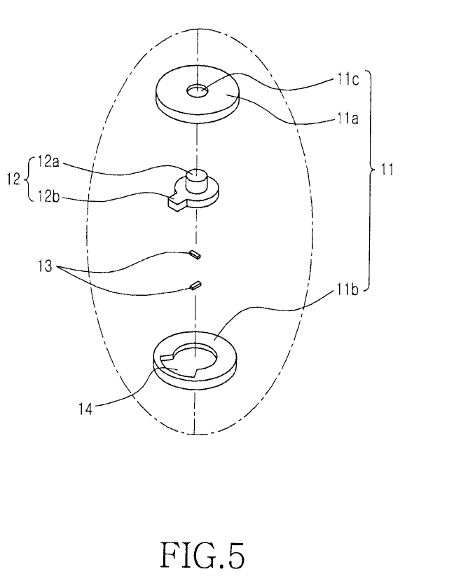

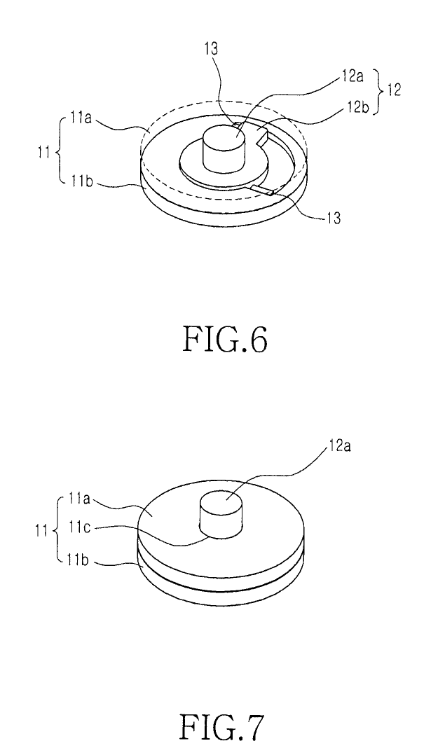

Referring to FIG. 5, each of the rivet stoppers 10 includes a rivet housing 11, a rivet 12 with a stopper protrusion 12b formed on it, and a plurality of louvers 13. The rivet housing 11 may be formed to include the rivet 12 and the louvers 13. The rivet 12 is provided in the rivet housing 11 to rotate along with the rotation of the elastic body 6, and the louvers 13 are provided in the rivet housing 11 to make contact at a rotation start position and a rotation end position of the stopper protrusion 12b on the rivet 12. (see FIG. 6). FIG. 7 illustrates a prospective view of a completed rivet assembly.

Referring to FIG. 5, the rivet housing 11 includes first and second housings 11a and 11b in the form of a disk to have the rivet 12 and the louvers 13 built in it. A rivet hole 11c is formed in the center of the first housing 11a so that a rivet protrusion 12a protruding from the center of the rivet 12 passes through the rivet hole 11c. A guide groove 14 is formed in the first and second housings 11a and 11b along circumferences of the first and second housings 11a and 11b in order to restrict a rotation angle of the stopper protrusion 12b.

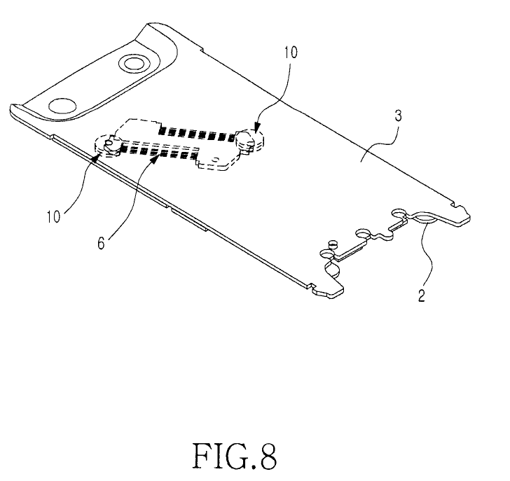

Referring to FIGS. 8 through 14, to explain the operation of the rotation of rivet 12, FIG. 8 illustrates guide groove 14 which is formed in the form of a fan, and a rotation angle/length of the guide groove 14 may be increased or decreased according to a sliding distance of the moving plate 3, as will be explained. The guide groove 14 is formed such that the first and second housings 11a and 11b are engaged with each other face-to-face so as to enable rotation of the stopper protrusion 12b.

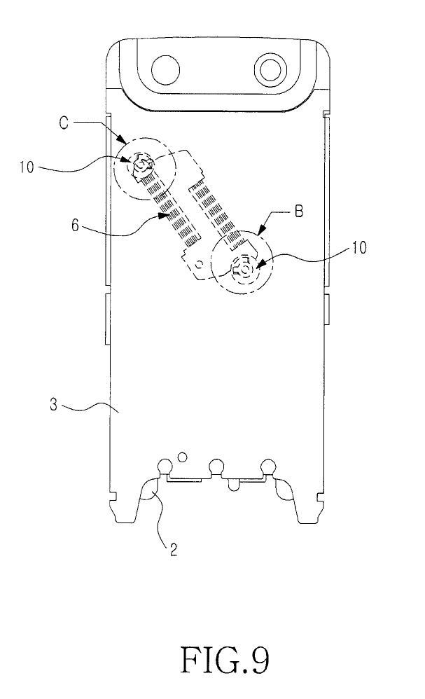

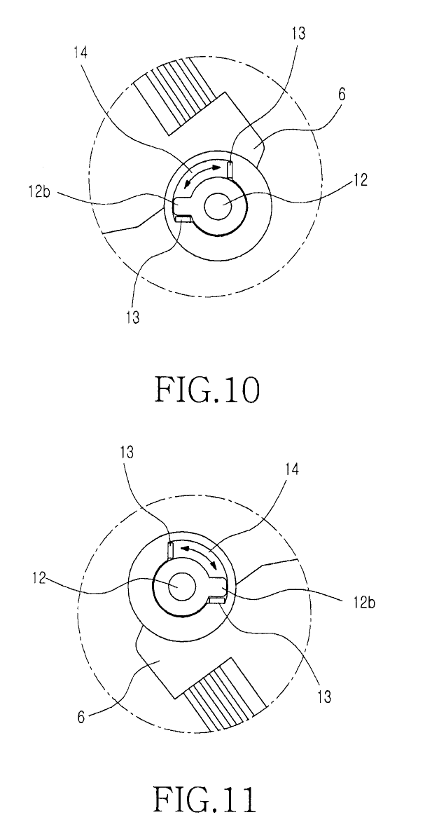

Referring to FIGS. 9 through 14, the stopper protrusion 12b protrudes from a circumferential side of the rivet 12 so that it can be guided along the guide groove 14. FIG. 10 illustrates stopper protrusion 12b engaging a first louver 13 at a first end of guide groove 14 and FIG. 11 illustrates stopper protrusion 1b engaging a second louver 13 at a second end of guide groove 14.

The rivet protrusion 12a protrudes along the central axis of the rivet 12 (see FIGS. 4 and 5) so that it may fit into a hole 6a formed in each of both ends of the elastic body 6 (see FIG. 8).

Operation of the sliding module for a slide-type portable terminal with a stopper device according to an embodiment of the present invention is now described.

Referring to FIGS. 4 through 8, the sliding module for a slide-type portable terminal with a stopper device includes the fixed plate 2, the moving plate 3 that may slide over the fixed plate 2, the elastic body 6, and the two rivet stoppers 10 that are rotatably engaged with both ends of the elastic body 6.

Each of the rivet stoppers 10 includes the rivet housing 11, the rivet 12 with the stopper protrusion 12b formed on it, and the plurality of louvers 13. The rivet housing 11 includes the first and second housings 11a and 11b in the form of a disk, and the first and second housings 11a and 11b are engaged such that the rivet protrusion 12a protruding from the center of the rivet 12 passes through the rivet hole 11c formed in the center of the first housing 11a.

The stopper protrusion 12b on the rivet 12 is rotatably engaged with the guide groove 14 formed in the first and second housings 11a and 11b.

One rivet protrusion 12a rotatably fits into the hole 6a formed in one end of the elastic body 6, while the other rivet protrusion 12a rotatably fits into the hole 6a formed in the other end of the elastic body 6. (See FIG. 4).

One rivet stopper 10 is provided on the top of the fixed plate 2 while the other rivet stopper 10 is provided on the bottom of the moving plate 3.

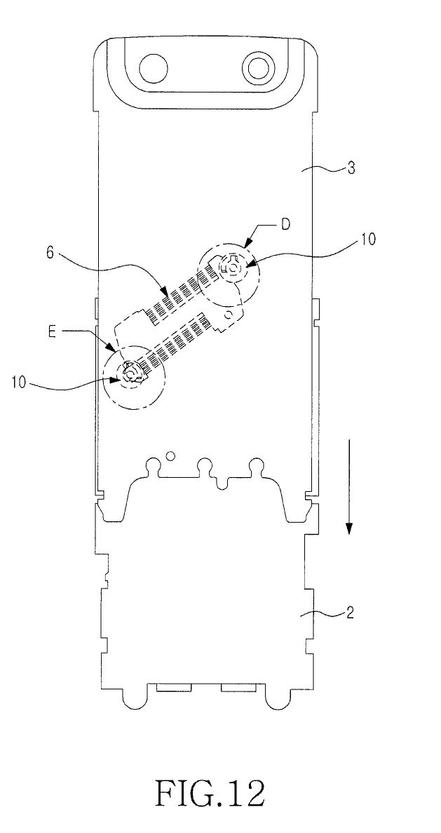

In this state, referring to FIGS. 12 through 14, if the moving plate 3 is slid over the fixed plate 2 (in direction of arrow, in FIG. 12), both ends of the elastic body 6 rotate and their associated rivets 12 also rotate. The stopper protrusion 12b also rotates along with the rotation of the rivet 12.

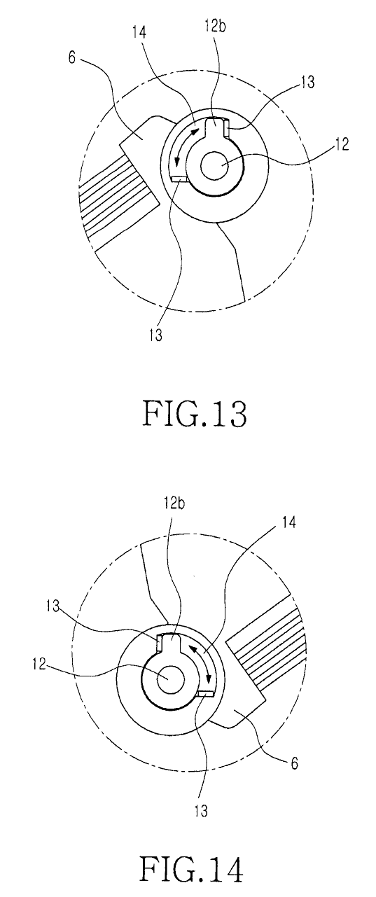

Referring to FIGS. 13 and 14, the stopper protrusion 12b rotates along the guide groove 14 formed in the first and second housings 11a and 11b, and the rotation is restricted when the stopper protrusion 12b makes contact with the louver 13 provided in the rotation end position of the stopper protrusion 12b.

The louvers 13 are provided at the rotation start position and the rotation end position of the stopper protrusion 12b in the guide groove 14, respectively.

Referring to FIGS. 9 through 11, if the moving plate 3 is slid over the fixed plate 2 back to its original position, the elastic body 6 rotates and the stopper protrusion 12b also rotates along with the rivet 12.

Referring to FIGS. 10 and 11, the stopper protrusion 12b rotates along the guide groove 14, and the rotation is restricted when the stopper protrusion 12b makes contact with the louver 13 provided in the rotation start position of the stopper protrusion 12b.

In this way, the sliding distance of the moving plate 3 is restricted by the rivet stoppers 10.

For example, if the sliding distance of the moving plate 3 is determined as 38 mm, the rotation length/angle of the guide groove 14 in each of the rivet stoppers 10 is determined according to the sliding distance.

Therefore, the stopper protrusion 12b rotates according to the sliding distance and the rotation is restricted when the stopper protrusion 12b makes contact with the louvers 13.

In addition, if the sliding distance of the moving plate 3 is determined as 40 mm or 43 mm, the rotation length of the guide groove 14 in each of the rivet stoppers 10 is increased to correspond to the desired sliding distance.

The rotation length of the guide groove 14 can be increased or decreased according to the sliding distance of the moving plate 3.

Herein, the sliding distance of the moving plate 3 ranges from 38 mm to 43 mm by way of example only. However, the sliding distance may also be below 38 mm, or above 43 mm.

A rivet stopper engaged with the fixed plate is provided at one end of the elastic body, another rivet stopper engaged with the moving plate is provided at the other end of the elastic body. The stopper protrusions of the rivets, which are provided on the respective rivet stoppers, rotate in opposite directions during sliding movement of the moving plate.

While a sliding module for a slide-type portable terminal with a stopper device has been shown and described with reference to certain exemplary embodiments of the present invention, it will be understood by those skilled in the art that various changes in form and details may be made therein without departing from the spirit and scope of the invention as defined by the appended claims and their equivalents.

What is claimed is:

1. A sliding module for a slide-type portable terminal, comprising a fixed plate, a moving plate slidable over the fixed plate, and an elastic body interposed between the fixed plate and the moving plate for providing an elastic force to slide the moving plate, the sliding module comprising:
a rivet stopper that is formed on each end of the elastic body wherein during a sliding movement of the moving plate both ends of the elastic body rotate and the sliding movement of the moving plate is restricted when rotation of the rivet stopper provided at the ends of the elastic body makes contact with limiting members.

2. The sliding module of claim 1, wherein the rivet stopper comprises:
a rivet housing;
a rivet provided in the rivet housing and having a stopper protrusion formed thereon, the rivet rotating along with the rotation of the elastic body; and
a plurality of louvers provided in the rivet housing operating as the limiting members wherein the limiting members are positioned at a rotation start position and a rotation end position of the stopper protrusion on the rivet.

3. The sliding module of claim 2, wherein the rivet housing includes:
first and second housings in a form of a disk,
a rivet hole formed in a center of the first housing so that a rivet protrusion protruding from a center of the rivet passes through the rivet hole, and
a guide groove for restricting a rotation angle of the stopper protrusion is formed in the first and second housings along circumferences of the first and second housings.

4. The sliding module of claim 3, wherein the guide groove is formed in a form of a fan.

5. The sliding module of claim 3, wherein the guide groove is formed such that the first and second housings are engaged with each other face-to-face.

6. The sliding module of claim 2, wherein the stopper protrusion protrudes from a circumferential side of the rivet.

7. The sliding module of claim 3, wherein the rivet protrusion fits into a hole formed in each of both ends of the elastic body.

8. The sliding module of claim 4, wherein a rotational angle/length of the guide groove is increased or decreased according to a sliding distance of the moving plate.

9. The sliding module of claim 2, wherein a rivet stopper engaged with the fixed plate is provided at one end of the elastic body, another rivet stopper engaged with the moving plate is provided at the other end of the elastic body, and wherein stopper protrusions of the rivets, which are provided on the respective rivet stoppers, rotate in opposite directions during sliding movement of the moving plate.

10. A terminal comprising:
a fixed plate;
a movable plate; and
a sliding module to enable the movable plate to slide with respect to the fixed plate, the sliding module comprising:
an elastic body interposed between the fixed plate and the moving plate for providing an elastic force to slide the moving plate, and:
a rivet stopper formed on each end of the elastic body rotatable about the ends of the elastic body, the rotation being limited when rotation of the rivet stopper makes contact with a limiting member.

11. The terminal of claim 10, wherein the rivet stopper comprises:
a rivet housing;
a rivet provided in the rivet housing and having a stopper protrusion formed thereon, the rivet rotating along with the rotation of the elastic body; and
a plurality of louvers provided in the rivet housing operating as the limiting members wherein the limiting members are positioned at a rotation start position and a rotation end position of the stopper protrusion on the rivet.

12. The terminal of claim 11, wherein the rivet housing includes:
first and second housings in a form of a disk;
a rivet hole formed in a center of the first housing so that a rivet protrusion protruding from a center of the rivet passes through the rivet hole; and
a guide groove for restricting a rotation angle of the stopper protrusion is formed in the first and second housings along circumferences of the first and second housings.

13. The terminal of claim 12, wherein the guide groove is formed in a form of a fan.

14. The terminal of claim 12, wherein the guide groove is formed such that the first and second housings are engaged with each other face-to-face.

15. The terminal of claim 11, wherein the stopper protrusion protrudes from a circumferential side of the rivet.

16. The terminal of claim 12, wherein the rivet protrusion fits into a hole formed in each of both ends of the elastic body.

17. The terminal of claim 13, wherein a rotational length of the guide groove is increased or decreased according to a sliding distance of the moving plate.

18. The terminal of claim 11, wherein a rivet stopper engaged with the fixed plate is provided at one end of the elastic body, another rivet stopper engaged with the moving plate is provided at the other end of the elastic body, and wherein stopper protrusions of the rivets, which are provided on the respective rivet stoppers, rotate in opposite directions during sliding movement of the moving plate.
